(19) United States
(12) Patent Application Publication
(10) Pub. No.: US 2013/0055284 A1
(43) Pub. Date: Feb. 28, 2013

(54) MANAGING SHARED COMPUTER RESOURCES

(71) Applicant: Simon L. Sabato, Saratoga, CA (US)

(72) Inventor: Simon L. Sabato, Saratoga, CA (US)

(73) Assignee: CISCO TECHNOLOGY, INC., San Jose, CA (US)

(21) Appl. No.: 13/220,586

(22) Filed: Aug. 29, 2011

(51) Int. Cl. G06F 9/46

(52) U.S. Cl. 718/106

(57) ABSTRACT

Various systems, processes, and products may be used to manage shared computer resources. In particular implementations, managing shared computer resources may include the ability to execute a first process on a first central processing unit and execute a second process on a second central processing units, wherein the first process and the second process are operable to access a first resource, and to determine at a mutex controller which of the first process and the second process is allowed to access the first resource at a given time.

### TECHNICAL FIELD

The present invention relates generally to computer resources, and more specifically to shared computer resources.

### BACKGROUND

Modern computer systems may include multiple processing units, which can each handle one or more processes (e.g., threads). Thus, many processes may be executed simultaneously in these computer systems. Typically, each process has its own resources (e.g., memory locations) that it accesses. However, in certain implementations, the processes may access shared resources, which can lead to race conditions and data instability.

### BRIEF DESCRIPTION OF THE DRAWINGS

FIG. 1 is a block diagram illustrating an example system for managing shared computer resources.

FIG. 2 is a flowchart illustrating an example process for managing shared computer resources.

FIG. 3 is a flowchart illustrating another example process for managing shared computer resources.

FIG. 4 is a block diagram illustrating an example implementation of a system for managing shared computer resources in a computer system.

### DETAILED DESCRIPTION

In one general implementation, a procedure for managing shared computer resources may include executing a first process on a first central processing unit, the first process operable to access a first resource, and executing a second process on a second central processing unit, the second process operable to access the first resource. The procedure may also include determining at a mutex controller which of the first process and the second process is allowed to access the first resource at a given time.

The access to computer resources being shared between processes may be managed to improve process performance. In particular implementations, the processes may be executing on different central processing units, and a mutex controller accessible by both of the processes may manage the access to one or more shared resources based on the processes requesting to use the shared resource(s).

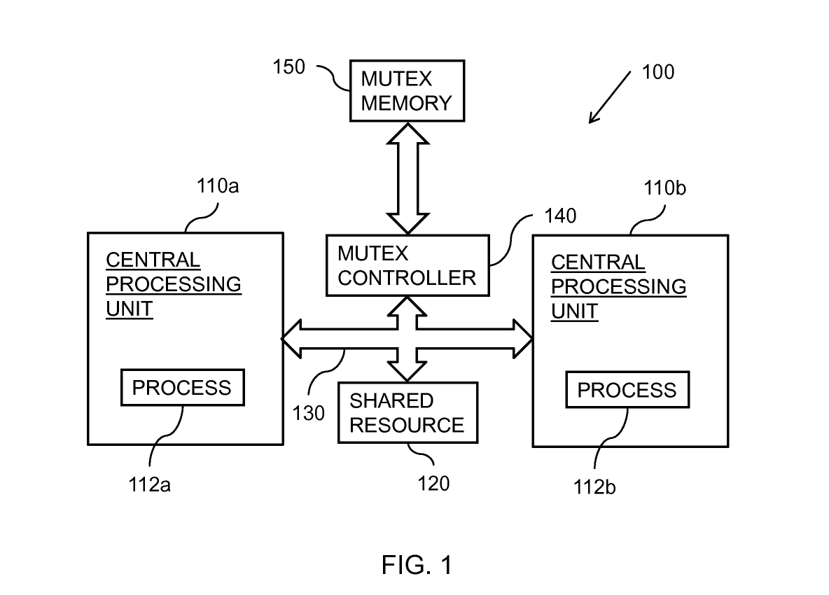

FIG. 1 illustrates an example system 100 for managing shared computer resources. System 100 includes a first central processing unit 110a that is executing a first process 112a and a second central processing unit 110b that is executing a second process 112b. Processes 112 may, for example, be programs, which can be implemented as software, firmware, or otherwise. Typically, only a portion of processes 112 is being executed by one of central processing units 110 at a time. Central processing units 110 may be microprocessors, microcontrollers, application specific integrated circuits, or any other devices for executing instructions in a logical manner.

Processes 112 typically have memory (e.g., registers) associated directly with them on their respective central processing units 110 and may use this memory to carry out their operations. During some phases of execution, however, processes 112 may need to access a shared resource 120. Shared resource 120 may, for example, be a memory resource or a processing resource. A memory resource may, for example, be a storage location (e.g., a register for a counter) or a storage device (e.g., a hard drive). A processing resource may, for example, be a graphics card. Processes 112 may access shared resource 120 over a computer network 130, which may, for example, be a bus (whether internal or external) or a local network (e.g., Ethernet or Universal Serial Bus).

Before accessing shared resource 120, processes 112 may first communicate with mutex controller 140. Modern programs often understand when a resource may be shared. For example, a program may understand that a graphics card, a hard drive, or a memory location may be shared. Moreover, operating systems (e.g., Windows) may have numerous mutex's that programs need to grab before doing various operations (e.g., owning the “clipboard” before putting data in it). These programs may, for example, have a set of operations like:
Grab_mutex( );
Perform operations involving shared resource;
Release_mutex( ).

Mutex controller 140 is responsible for managing access to shared resource 120 so that processes 112 do not attempt to access it simultaneously. Mutex controller 140 may be a microprocessor, a microcontroller, an application specific integrated circuit, a field programmable gate array, or any other type of hardware device that can implement instructions in a logical manner. Mutex controller 140 may, for example, be integrated on a chip set, a network chip, or a memory chip.

In operation, when one of processes 112 determines that it requires access to shared resource 120, the process may contact mutex controller 140 to determine whether shared resource 140 is available. If the shared resource is available, mutex controller 140 may set an indicator that informs the process that the shared resource is available to that process. The process may then understand that access to the shared resource is allowed and access the resource. When the process is through using the shared resource, the process may again contact mutex controller 140 to inform it that the process no longer requires the shared resource.

When the other of processes 112 determines that it requires access to shared resource 140, that process may also contact mutex controller 140 to determine whether the shared resource is available. If the shared resource is available, mutex controller 140 may set an indicator that informs the other process 112 that the shared resource is available to that process, and the process may then understand that access to the shared resource is allowed and access the resource.

However, if the first process is still using the shared resource, mutex controller 140 may refuse to set the indicator for the other process. Thus, the other process may understand that the shared resource is not available and not attempt to access the shared resource. The other process may try to access another resource to fulfill its needs or try to access the shared resource again in the future.

In particular implementations, mutex controller 140 may determine whether the shared resource is available by examining a memory location associated with the shared resource in a mutex memory 150. Mutex memory 150 may, for example, be a set of flip-flops, a portion of registers or RAM containing locations associated with various shared resources. Registers, for instance, would typically provide a relatively smaller number of memory locations, while RAM could provide a larger number (e.g., millions) of memory locations. Mutex memory 150 may be available exclusively or non-exclusively to mutex controller 140. Mutex memory 150, however, does not need to be integrated with mutex controller 140.

Mutex memory 150 may store, among other things, an identifier for the process 112 that currently has permission to use shared resource 120. The shared resource may, for example, be available if the associated memory location has a certain value (e.g., zero). If the shared resource is available, mutex controller 140 may set an indicator indicating that the resource is available to the process by placing the process identifier in a memory location associated with the resource. The process may then understand that it may access the resource by reading back its identifier from the memory location.

To release the resource after use, the process may generate a release request. The mutex controller 140 may determine whether the request is a valid request to release the resource. For example, the mutex controller may determine whether a process identifier in the request is equal to the value in the memory location. If the resource request is a valid release request, the mutex controller may set an indicator to indicate that the resource is available by setting the value in the memory location associated with the resource to a certain value (e.g., zero).

System 100 has a variety of features. For example, processes 112 may access shared resource 120 in a controlled, sequential manner. Thus, simultaneous access to the shared resource, which can cause instability, may be avoided. Additionally, the management of the shared resource may be implemented without advanced bus techniques (e.g., bus locking), processor techniques (e.g., test-and-set instructions), which not all central processing units support, and/or software techniques, which are typically complex and slower. Thus, shared resource management may be implemented in a wide range of computer environments, including ones that include different types of central processing units. Furthermore, system 100 may be used to manage access to a number of shared resources. For instance, mutex memory 150 may have a number of locations that are each associated with a shared resource. Thus, mutex controller 140 may manage resource access requests for a number of resources.

System 100 may also be useful for avoiding system wait conditions. A common problem that occurs with programs is that when an error occurs in a program during the time it has control of a shared resource and the program aborts without releasing the shared resource, other programs end up waiting for the shared resource. In system 100, however, after a process closes, aborts, or otherwise ceases operating, an operating system could scan mutex memory 150 and determine whether an identifier for the process is present, indicating that the shared resources was taken. The operating system could then request mutex controller 140 to release the mutex (e.g., by writing the process identifier to the mutex memory), which would clear the mutex for other processes to use.

Although mutex controller 140 and mutex memory 150 are shown as being separate from central processing units 110, in certain implementations, mutex controller 140 and mutex memory 150 could be located on one of the central processing units. For example, mutex controller 140 could be located on central processing unit 110a, and mutex memory 150 could be a set of registers of central processing unit 110a. If the central processing unit has Peripheral Component Interconnect Express (PCIe) ports on it, for instance, the mutex controller could be integrated on the chip and still be visible via the PCIe bus to other devices using the PCIe bus. Moreover, the mutex controller would not need any particular software on the host central processing unit or take up any processing cycles.

Additionally, central processing units 110 could be located in the same physical housing. For example, computer network 130 could be an inter-integrated circuit (I2C) bus, which typically does not have bus locking Devices coupled to such busses (e.g., fans, hard drives, etc.) may contain central processing units that share resources with the main central processing unit(s) of a local computer system (e.g., counters in RAM for system errors).

Mutex controller 140 may also be able to manage access to a shared resource for multiple (e.g., three or more) central processing units. The central processing units may be coupled to each other, and, hence, access the mutex controller, by the same bus or a collection of busses.

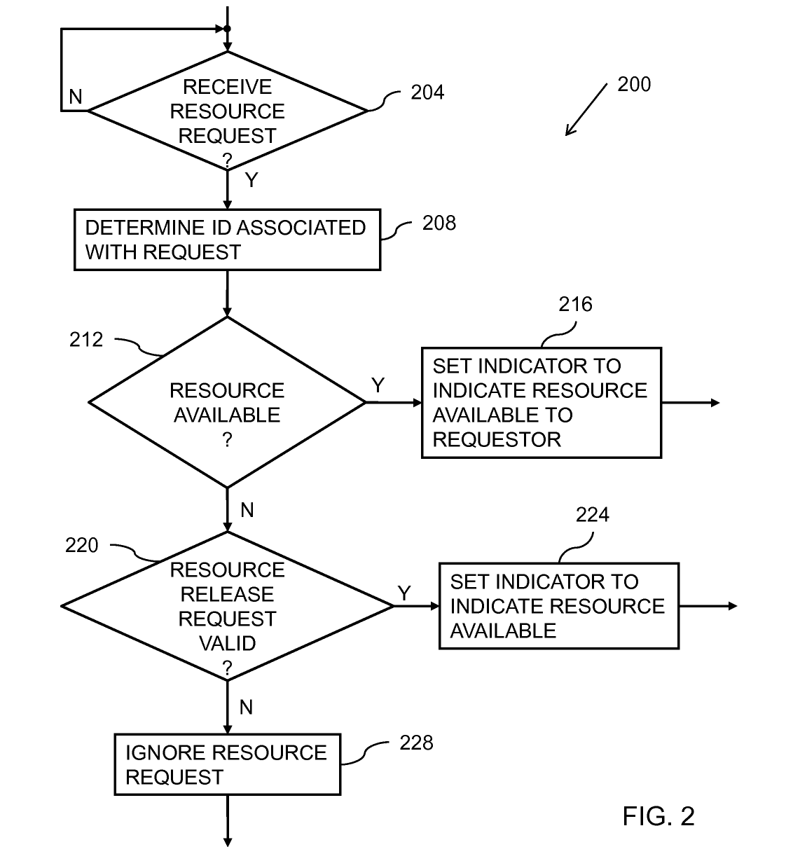

FIG. 2 illustrates an example procedure 200 for managing shared computer resources. Procedure 200 may, for example, be implemented by a device like mutex controller 140.

Procedure 200 calls for determining whether a resource request has been received (operation 204). A resource request may, for example, be a request for access to a portion of memory (e.g., a counter) or a processing device (e.g., a graphics card) and may originate from a process (e.g., a program or portion thereof). Procedure 200 may make this determination on any appropriate basis (e.g., time or event). If a resource request has not been received, procedure 200 calls for continuing to check whether a resource request has been received.

Once a resource request has been received, procedure 200 calls for determining an identifier associated with the request (operation 208). If the resource request is from a process, for example, the identifier may be a process identifier. Procedure 200 also calls for determining whether the shared resource is available (operation 212). Determining whether the shared resource is available may, for example, be accomplished by determining whether a memory location associated with the resource is available. The memory location may, for example, be a register, and the memory location may be available if it has a certain value (e.g., zero).

If the shared resource is available, procedure 200 calls for setting an indicator to indicate that the resource is available to the requestor (operation 216). Setting the indicator may, for example, be accomplished placing the identifier in a memory location associated with the resource. Procedure 200 is then at an end (e.g., it may stop or return to determine wither another resource request has been received).

If the shared resource is not available, however, procedure 200 calls for determining whether the resource request is a valid request to release the resource (operation 220). Determining whether the resource request is a valid release request may, for example, be accomplished by determining whether the identifier is equal to a value in the memory location. If the resource request is a valid release request, procedure 200 calls for setting an indicator to indicate that the resource is available (operation 224). For example, the value in a memory location associated with the resource may be set to a certain value (e.g., zero). Procedure 200 is then at an end.

If the resource request is not a valid resource release request, procedure 200 calls for ignoring the resource request (operation 228). For example, the resource request may be discarded. Procedure 200 is then at an end.

Procedure 200 may be repeated many times during the course of a process. In fact, in certain implementations, procedure 200 may be repeated many times before a process is able to access a shared resource for a specific operation (e.g., if the resource is occupied for an extended period).

In particular implementations, a mutex controller may also provide a retry message to a process if the requested shared resource is not available. In certain situations, for example, the process could be instructed to retry again and again until the shared resource is released. This would remove the burden of the process having to confirm whether it had the requested resource, but could also prevent the process from performing another operation if the shared resource is unavailable.

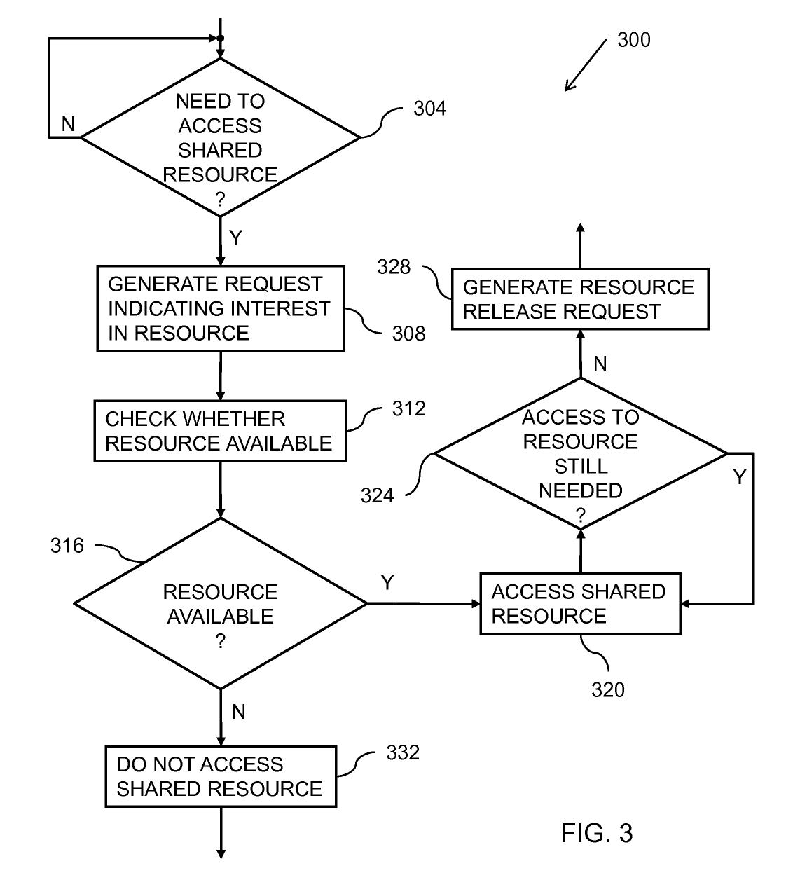

FIG. 3 illustrates an example procedure 300 for accessing a shared computer resource. Procedure 300 may, for example, be performed by a process (e.g., software, firmware, or a portion thereof) executing on a central processing unit.

Procedure 300 calls for determining whether the process requires access to a shared resource (operation 304). The process may, for example, accomplish this if it recognizes that a resource is shared. Procedure 300 may make this determination on any appropriate basis (e.g., time or event) If the process does not need to access a shared resource, procedure 300 calls for continuing to check whether the process needs to access a shared resource.

Once the process needs to access a shared resource, procedure 300 calls for generating a request indicating interest in the resource (operation 308). For example, the process may attempt to write an identifier for the process (e.g., a process identifier) to a memory location associated with the shared resource. The memory location may be located on the same central processing unit chip that is executing the process (e.g., a register) or at a different location (e.g., RAM or a remote memory).

Procedure 300 also calls for checking whether the shared source is available (operation 312) and determining whether the resource is available (operation 316). For example, the process may read a value stored in a memory location and determine whether the read value equals the identifier for the process. If the shared resource is available, procedure 300 calls for the process to access the shared resource (operation 320). Accessing the shared resource may, for example, entail having the shared resource perform processing or storage operations.

Procedure 300 also calls for determining whether access to the shared resource is still needed (operation 324). If access to the shared resource is still needed, procedure 300 calls for continuing to access the shared resource (operation 320). If, however, access to the shared resource is no longer needed, procedure 300 calls for generating a release request for the shared resource (operation 328). A release request may, for example, include an identifier for the process that is currently using the shared resource. Procedure 300 is then at an end.

Returning to operation 316, if the shared resource is not available, procedure 300 calls the process to not access the shared resource (operation 336). Procedure 300 is then at an end.

Procedure 300 may be repeated many times during the course of a process. In fact, in certain implementations, procedure 300 may be repeated many times before a process is able to access a shared resource for a specific operation (e.g., if the resource is occupied for an extended period).

The flowcharts and block diagrams in the figures illustrate the architecture, functionality, and operation of systems, methods, and computer program products of various implementations of the disclosure. In this regard, each block in the flowchart or block diagrams may represent a module, segment, or portion of code, which can include one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or the flowchart illustration, and combination of blocks in the block diagrams and/or flowchart illustration, can be implemented by special purpose hardware-based systems that perform the specified function or acts, or combinations of special purpose hardware and computer instructions.

As will be appreciated by one skilled in the art, aspects of the present disclosure may be implemented as a system, method, or computer program product. Accordingly, aspects of the present disclosure may take the form of an entirely hardware environment, an entirely software embodiment (including firmware, resident software, micro-code, etc.), or an implementation combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be a tangible medium that can contain or store a program for use by or in connection with an instruction execution system, apparatus, or device.

A computer readable signal medium may include a propagated data signal with computer readable program code embodied therein, for example in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any medium, including but not limited to wireless, wireline, optical fiber cable, RF, etc. or any suitable combination of the foregoing.

Computer program code for carrying out operations for aspects of the disclosure may be written in any combination of one or more programming languages such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described with reference to flowchart illustrations and/or block diagrams of methods, apparatus (systems), and computer program products according to implementations. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the functions/acts specified in the flowchart and/or block diagram block or blocks.

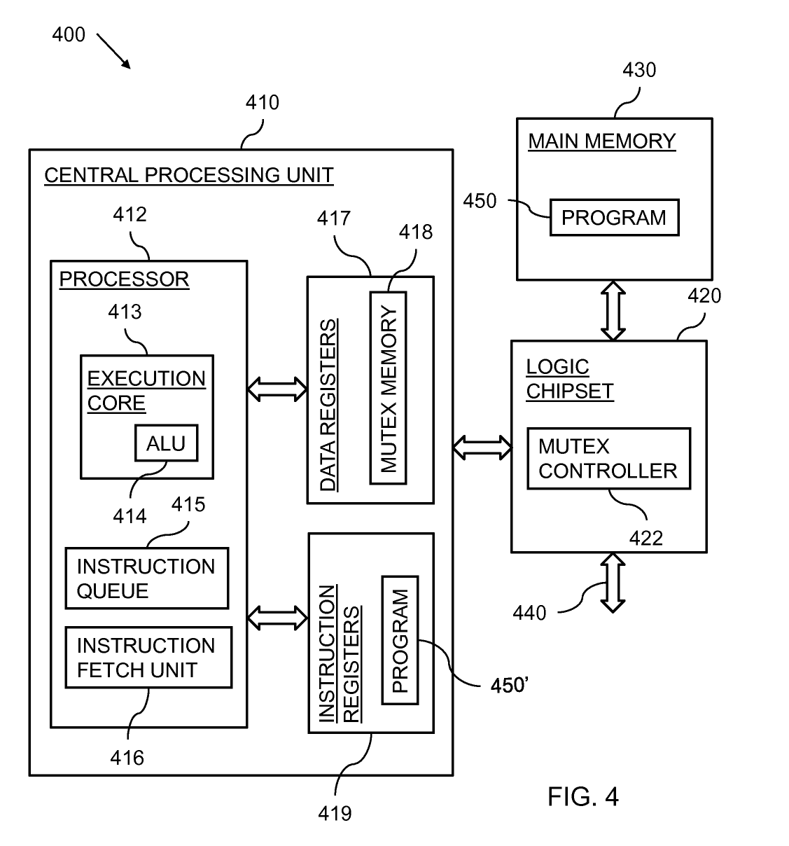

FIG. 4 illustrates an example computer system 400 in which a system for managing shared computer resources may be implemented. System 400 includes a central processing unit 410, a logic chipset 420, and main memory 430.

Central processing unit 410 includes a processor 412, data registers 417, and instruction registers 419. Processor 412 includes an execution core 413, an instruction queue 415, and an instruction fetch unit 416. Execution core 413 is responsible for processing data under the direction of process instructions (e.g., from software) and includes an arithmetic logic unit (ALU) 414 that assists in executing the instructions. In certain implementations, execution core 413 may be capable of simultaneously executing multiple independent hardware threads of execution. Instruction fetch unit 416 is responsible for fetching and ordering instructions for execution. Instruction fetch unit 416 is coupled to instruction queue 415, to which the instruction fetch unit dispatches instructions and from which instructions are issued to execution core 413 for execution.

Data registers 417 locally store the data on which execution core 413 operates (e.g., source operands). The data stored by the registers may, for example, include fixed-point values, floating-point values, vector values, decimal values, condition code values, count values, and/or any other appropriate type of data. Data registers 417 also store the data that results from operations (e.g., destination operands). The data may also be stored at different locations (e.g., main memory 430 or a data cache). In particular implementations, data registers 417 may be general purpose registers. Thus, they may store data or pointers (e.g., addresses) to data. The number of data registers is typically limited to a size determined to provide adequate storage capacity while meeting desired access latency and/or power consumption targets.

Instruction registers 419 locally store the instructions that execution core 413 executes. The instructions may also be stored at different locations (e.g., main memory 430 and/or an instruction cache).

Logic chip set 420 is responsible for implementing the core logic for system 400. In a particular implementation, logic chip set 420 may include two chips, one for controlling faster capabilities (e.g., for accessing main memory 430 and/or graphics capabilities) and a second for controlling slower capabilities (e.g., for accessing disk drives, peripherals, and computer networks).

Main memory 430 is responsible for storing an enlarged list of the instructions being executed, along with the associated data. Data registers 417 may store specific data from main memory 430 as needed, and instruction registers 419 may store specific instructions from main memory 430 as needed. In particular implementations, main memory 140 may include random access memory (RAM).

In the illustrated implementation, main memory 430 includes a program 450, which is one of the processes under execution by central processing unit 410. As part of its operations, central processing unit 410 moves portions (i.e., one or more instructions) of program 450 (denoted as 450′) into instruction registers 419 as needed.

Additionally, logic chipset 430 includes a mutex controller 422, and some of data registers 417 are allotted to form a mutex memory 418. Thus, when program 450 requires use of a shared resource, to which central processing unit 410 may be coupled through bus 440, program 450 may generate an inquiry regarding whether the shared resource is available, and mutex controller 422 may determine whether the shared resource is available and set an appropriate indicator in mutex memory 418 if the shared resource is available. Program 450 may then determine whether the resource is available by checking the indicator. Then when program 450 is finished with the shared resource, it may generate release request, which mutex controller 422 may analyze and clear the indicator, if appropriate.

Furthermore, when a process being executed by another central processing unit desires to use a shared resource, the process may generate an inquiry regarding whether the shared resource is available and send it to mutex controller 422 (e.g., via bus 440). Mutex controller 422 may then determine whether the shared resource is available for the process and set an appropriate indicator in mutex memory 418 if the shared resource is available. The process may then determine whether the resource is available by checking the indicator. When the process is finished with the shared resource, it may generate release request, which mutex controller 422 may analyze and clear the indicator, if appropriate.

Although FIG. 4 illustrates one example computer system in which a system for managing shared computer resources may be implemented, other computer systems are possible. For example, the mutex memory could be part of main memory, which would potentially provide an increased amount of storage locations (e.g., thousands or millions). As another example, the logic chip set, along with the mutex controller, could be on the central processing unit. As an additional example, the mutex controller could be implemented on the central processing unit without the logic chipset. As a further example, the process under execution does not have to be stored in main memory. For example, it could be firmware.

As another example, a computer system may include a cache memory that is responsible for storing some of the data in the main memory. A processor may typically access cache memory faster than main memory and, hence, attempt to store the more commonly accessed data in the cache memory to speed up operations. The cache memory could be implemented on-chip or off-chip.

The terminology used herein is for the purpose of describing particular implementations only and is not intended to be limiting. As used herein, the singular form “a”, “an”, and “the” are intended to include the plural forms as well, unless the context clearly indicates otherwise. It will be further understood that the terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore.

The corresponding structure, materials, acts, and equivalents of all means or steps plus function elements in the claims below are intended to include any structure, material, or act for performing the function in combination with other claimed elements as specifically claimed. The description of the present implementations has been presented for purposes of illustration and description, but is not intended to be exhaustive or limited to the implementations in the form disclosed. Many modifications and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated.

A number of implementations have been described for managing shared computer resources, and several others have been mentioned or suggested. Moreover, those skilled in the art will readily recognize that a variety of additions, deletions, modifications, and substitutions may be made to these implementations while still achieving management of shared computer resources. Thus, the scope of the protected subject matter should be judged based on the following claims, which may capture one or more aspects of one or more implementations.

1. A system for managing shared computer resources, the system comprising:
a first central processing unit executing a first process, the first process operable to access a first resource;
a second central processing unit executing a second process, the second process operable to access the first resource;
a bus coupling the first central processing unit to the second central processing unit; and
a mutex controller coupled to the bus, the mutex controller operable to determine which of the first process and the second process is allowed to access the first resource at a given time.

2. The system of claim 1, wherein the mutex controller determines which process is allowed to access the first resource at a given time by:
receiving a request to access the first resource from one of the processes; and
determining whether a memory location associated with the first resource indicates that the first resource is available.

3. The system of claim 2, wherein the mutex controller determines whether the memory location is storing a predetermined value to determine whether a memory location associated with the first resource is available.

4. The system of claim 2, wherein the mutex controller is further operable to place an identifier for the process in the memory location if the memory location indicates that the first resource is available.

5. The system of claim 4, wherein the processes are operable to:
access the memory location; and
determine whether they have access to the first resource based on the data stored therein.

6. The system of claim 2, wherein the mutex controller is further operable to generate a retry request for the process if the shared resource is not available.

7. The system of claim 1, wherein the mutex controller is further operable to:
receive a resource release request for the first resource from one of the processes;
determine whether the resource release request is valid; and
make the associated memory location indicate that the resource is available if the resource release request is valid.

8. The system of claim 6, wherein the mutex controller is further operable to ignore the resource release request if the release request is not valid.

9. The system of claim 1, further comprising:
a third central processing unit executing a third process, the third process operable to access the first resource;
wherein the mutex controller is further operable to determine which of the three processes is allowed to access the first resource at a given time.

10. A method for managing shared computer resources, the method comprising:
executing a first process on a first central processing unit, the first process operable to access a first resource;
executing a second process on a second central processing unit, the second process operable to access the first resource; and
determining at a mutex controller which of the first process and the second process is allowed to access the first resource at a given time.

11. The method of claim 10, wherein determining which process is allowed to access the first resource at a given time comprises:
receiving a request to access the first resource from one of the processes; and
determining whether a memory location associated with the first resource indicates that the first resource is available.

12. The method of claim 11, wherein determining whether a memory location associated with the first resource is available comprises determining whether the memory location is storing a predetermined value.

13. The method of claim 11, further comprising placing an identifier for the process in the memory location if the memory location indicates that the first resource is available.

14. The method of claim 13, further comprising:
accessing the memory location with the processes; and
determining whether the processes have access to the first resource based on the data stored therein.

15. The method of claim 11, further comprising generating a retry request for the process at the mutex controller if the shared resource is not available.

16. The method of claim 10, further comprising:
receiving a resource release request for the first resource from one of the processes;
determining whether the resource release request is valid; and
making the associated memory location indicate that the resource is available if the resource release request is valid.

17. The method of claim 16, further comprising ignoring the resource release request if the release request is not valid.

18. The method of claim 10, further comprising:
executing a third process on a third central processing unit, the third process operable to access the first resource; and
determining at the mutex controller which of the three processes is allowed to access the first resource at a given time.
